(19) United States
(12) Patent Application Publication
(10) Pub. No.: US 2007/0053414 A1
(43) Pub. Date: Mar. 8, 2007

(54) Full duplex multimode transceiver

(75) Inventors: Adrian W Payne, Horley (GB); Richard J. Caldwell, Reigate (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/554,600

(22) PCT Filed: Apr. 20, 2004
(86) PCT No.: PCT/IB04/01361

§ 371 Date: Oct. 27, 2005

(30) Foreign Application Priority Data
May 1, 2003 (GB) 0309978.5

(51) Int. Cl. H04B 1/00

(52) U.S. Cl. 375/141

(57) ABSTRACT

A method of operating a multimode transceiver comprises simultaneously transmitting (Tx) a signal having a relatively wide output frequency spectrum and receiving (Rx) a signal having a frequency spectrum narrower than that of the output frequency spectrum, but lying in the same band. A notch is introduced by a filter (18, 19, 20) into the output spectrum of the transmitted signal at a position corresponding to the received signal. The notch is adapted in response to at least one operating characteristic of the transceiver. The notch depth and bandwidth may be a function of the received and transmitted signal strengths, the relative frequency displacements of the received and transmitted signals and of the extent to which a degradation in the transmitted signal quality due to the notch can be tolerated. Furthermore adaptive cancellation (34) can be effected in the multimode transceiver using is for example the centre of the transmitted frequency spectrum or a portion of the transmit frequency spectrum at the centre frequency of the receive signal spectrum.

The present invention relates to the simultaneous transmission and reception of signals in a multimode transceiver. More particularly the present invention is concerned with receiving a narrowband signal which lies within the band of a simultaneously transmitted wideband signal. In certain operating conditions the received narrowband signal spectrum lies within the spectrum of the transmit signal.

A well known problem in radio communication is that of a receiver receiving a strong transmission from a nearby transmitter that has coupled into the receiver. Normally it is arranged to separate the transmit and receive signals in frequency or time. However for a dual mode transceiver it may not be possible to arrange for such separation because simultaneous receive and transmit may be required.

To achieve simultaneous reception and transmission in a dual mode transceiver the transmit signal that couples into the receiver must be cancelled. This can only be done if the channel bandwidths are different. The cancellation requirements are severe and it is only likely to work for strong received signals. This is because the transmitted signal that couples into the receiver's antenna will be much higher than the narrow-band received signal and will continuously vary in amplitude, phase and delay. The cancellation mechanism must continuously estimate and cancel this varying interfering signal and must work over a wide bandwidth depending on the frequency displacement of the two systems.

U.S. Pat. No. 6,115,368 discloses a spread spectrum CDMA communications system for communicating data and/or digitised voice between a plurality of users to a plurality of personal communications network (PCN) units. In order to enable the CDMA system to operate within the same geographical region as occupied by an existing microwave system which operates on narrowband channels lying within the bandwidth of the CDMA system, the transmitter section of the PCN base station has an adjustable notch filter which inserts one or more notches in the power spectrum transmitted from the base station. The notch filter has its centre frequency and bandwidth set so as to notch the power spectrum from the PCN transmitter at whatever desired frequency and bandwidth of the fixed-service, microwave channel. If the base station is programmed with the frequency and bandwidth of each fixed-service microwave user which transmits across the geographic region of the base station it can send a command signal to the PCN unit indicating which portions of spectrum to notch out with the adjustable notch filter. In an alternative or additional embodiment the base station and/or PCN unit has a sensor which detects the microwave power or energy of one or more fixed-service, microwave channels. The sensor determines the centre frequency and the bandwidth of the fixed-service microwave channel, and then the controller adjusts the adjustable notch filter to notch out the spread-spectrum processed data at those frequencies and bandwidths. This cited system uses the adjustable notch filter to protect the fixed-service microwave system from interference by the CDMA system. However there is no consideration given to safeguarding a narrowband transmission intended for the base station from a simultaneous wideband transmission by the base station.

The problem of simultaneous transmission and reception is likely to occur with multimode transceivers operating in accordance with, for example, the IEEE 802.11b standard and Bluetooth™, both of which operate in the ISM (Industrial, Scientific and Medical) band. Bluetooth™ transmissions are frequency hopped narrowband transmissions lying within the band of the IEEE 802.11b system.

An object of the present invention is to protect a receive signal when simultaneously receiving and transmitting signals using a multimode transceiver.

According to one aspect of the present invention there is provided a method of operating a multi-mode transceiver comprising simultaneously transmitting a signal having a relatively wide output frequency spectrum and receiving a signal having a frequency spectrum narrower than that of the output frequency spectrum but lying within the band of the transmit signal, introducing at least one notch into the output spectrum of the transmitted signal to enhance reception of the received signal and adapting at least one parameter of the notch in response to at least one operating characteristic of the transceiver.

According to a second aspect of the present invention there is provided a multimode transceiver comprising a receiver for receiving a signal having a relatively narrow frequency spectrum, a transmitter for transmitting a signal having an output frequency spectrum wider than that of the frequency spectrum of the received frequency spectrum, the narrow frequency spectrum and the output frequency spectrum lying within the same band, means for introducing at least one notch into the output spectrum of the transmitted signal to enhance reception of the received signal and adapting means for adapting at least one parameter of the at least one notch in response to at least one operating characteristic of the transceiver.

By means of the present invention the same transceiver protects a narrowband received signal whilst simultaneously transmitting a wideband signal whose degradation due to the presence of the notch has been reduced. The size of the notch may be varied dynamically to suit the frequency and bandwidth of the narrowband signal thereby enabling the degree of loss of the transmitted signal to be optimised. The notch depth and bandwidth may be adapted as a function of the received and transmitted signal strengths, the relative frequency displacements of the received and transmitted signals and of the extent to which a degradation in the transmitted signal quality due to the notch can be tolerated. Furthermore the multimode transceiver may enable adaptive cancellation in the receive signal to be effected using for example the centre frequency of the transmit signal and/or an overlapping potion of the transmit signal at the centre frequency of the receive signal.

The present invention will now be described, by way of example, with reference to the accompanying drawings, wherein:

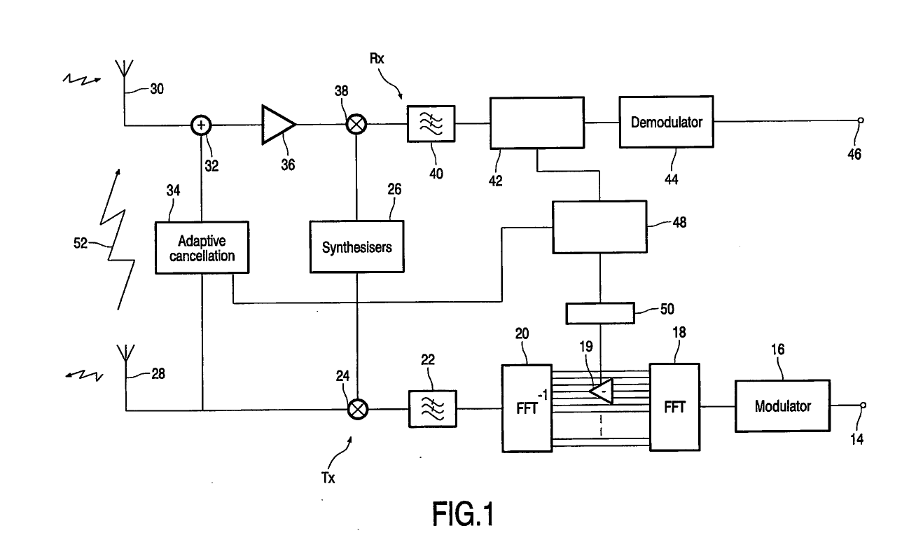

FIG. 1 is a block schematic diagram of a simplified configurable dual mode transceiver,

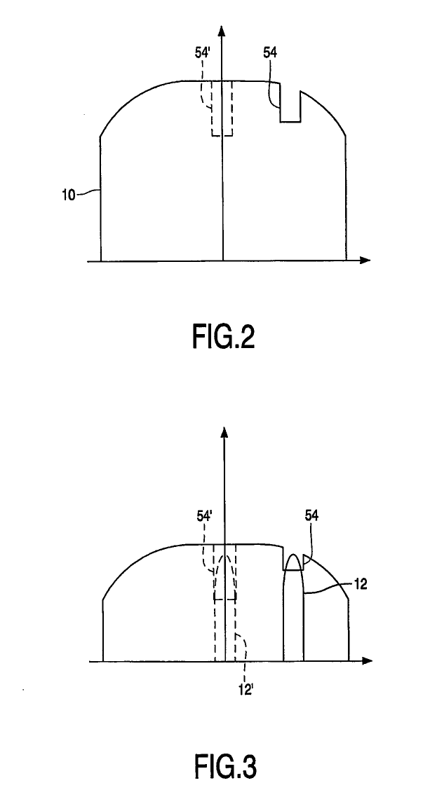

FIG. 2 is a diagram of the frequency spectrum of a transmitted signal,

FIG. 3 is a diagram of the frequency spectrum of a received signal,

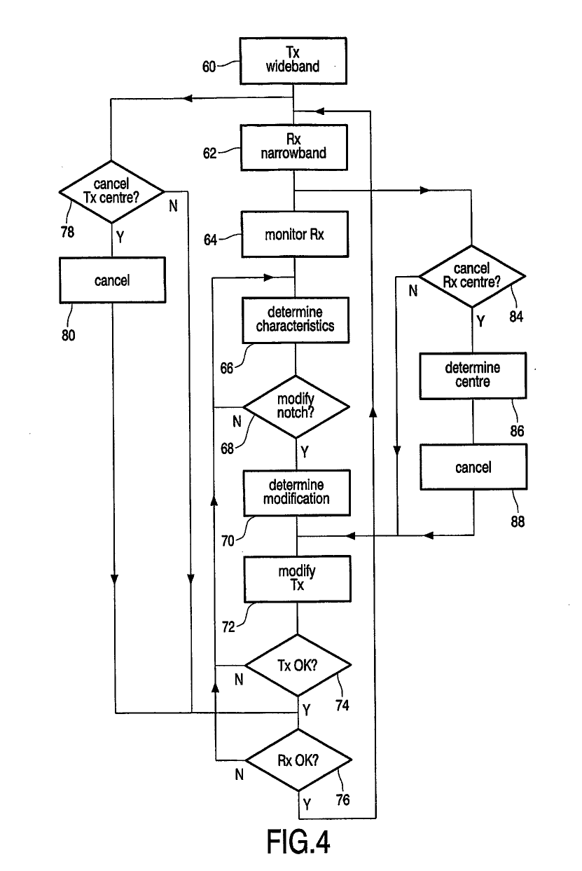

FIG. 4 is a flow chart relating to an implementation of the present invention,

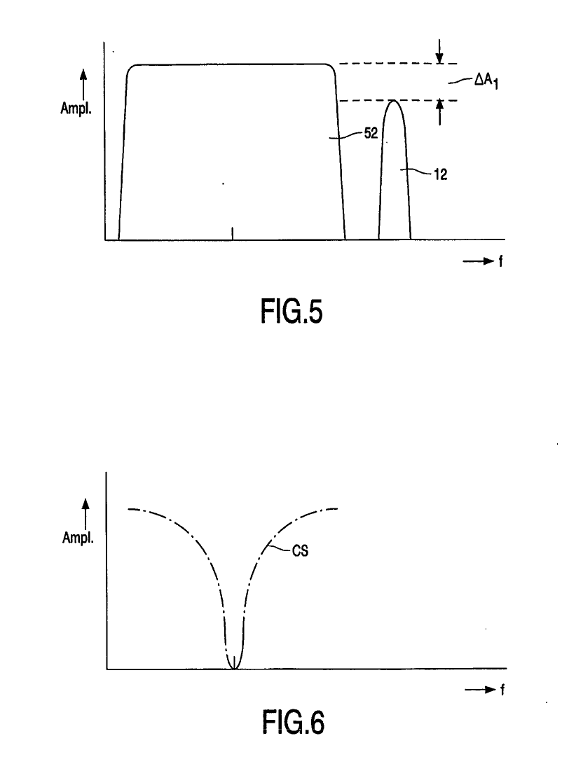

FIG. 5 is a graph illustrating an example of a coupled through portion of a transmit signal spectrum without notching and a non-overlapping receive signal spectrum,

FIG. 6 is a graph illustrating a cancelling signal at the centre of the transmit signal spectrum,

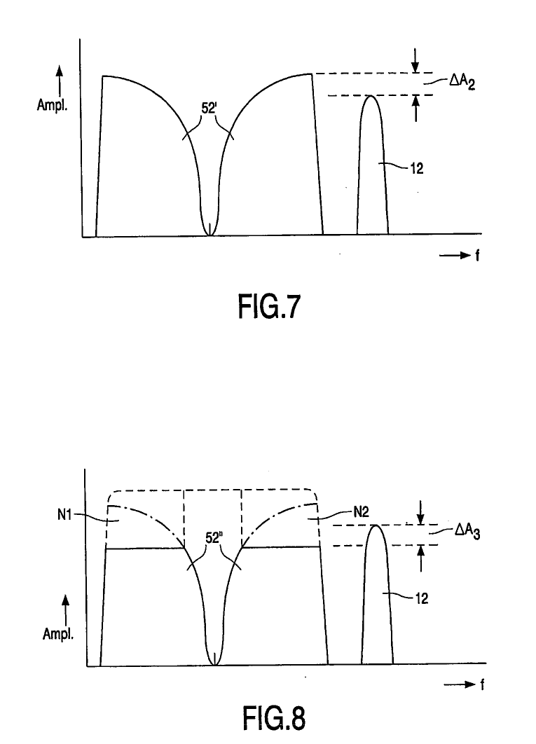

FIG. 7 is a graph illustrating the effect of using the cancelling signal shown in FIG. 6 on the signal spectra shown in FIG. 5,

FIG. 8 is a graph illustrating the effects of notches in the transmit signal spectrum and signal cancellation on the signal spectra shown in FIG. 5,

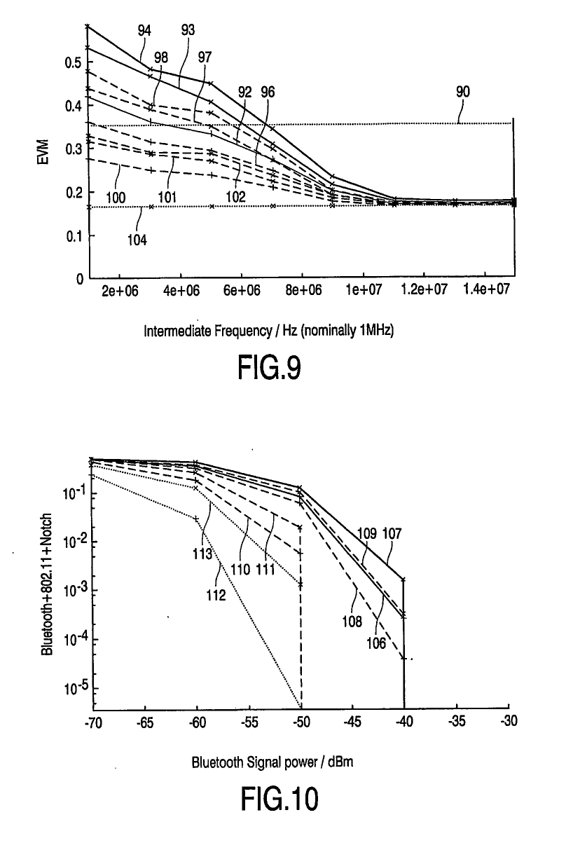

FIG. 9 is a graph showing the simulation results of the transmit error vector magnitude (EVM) of the IEEE 802.11b standard as a function of notch bandwidth and depth and offset from the centre of the transmitter frequency spectrum, and

FIG. 10 is a graph showing the simulation results of putting a notch in the transmit frequency spectrum of a signal transmitted in accordance with the IEEE 802.11b standard to facilitate the simultaneous reception of a signal conforming to the Bluetooth™ standard.

In the drawings the same reference numerals have been used to indicate corresponding features.

Referring to FIGS. 1 to 3, the illustrated configurable multimode transceiver is a dual IEEE 802.11b and Bluetooth™ transceiver. However in order to facilitate an understanding of the present invention, only the Bluetooth™ receiver and the IEEE 802.11b transmitter have been shown but it is to be understood that complementary Bluetooth™ transmitter and IEEE 802.11b receiver would be part of the transceiver. Both operating standards use the ISM band but IEEE 802.11b requires a wide frequency spectrum 10 (FIG. 2) whereas Bluetooth™ has a narrow band spectrum 12 (FIG. 3) lying within the spectrum 10 and which is frequency hopped. The transceiver comprises a transmitting branch Tx and a receiving branch Rx.

The transmitting branch Tx comprises an input 14 for bits to be transmitted in accordance with the IEEE 802.11b standard. The input 14 is coupled to a modulator 16 which has an output coupled to a Fast Fourier Transform (FFT) filter 18. An inverse FFT (FFT⁻¹) filter 20 is coupled to an output of the FFT 18. A low pass filter 22 is coupled to an output of the FFT⁻¹ 18. The signal from the low pass filter 22 is frequency up-converted in a mixer 24 which is also coupled to frequency synthesisers denoted by the block 26. A transmitter antenna 28 is coupled to an output of the mixer 24.

The receiving branch Rx comprises an antenna 30 coupled by way of a frequency cancelling circuit 32 to which is connected an adaptive frequency cancellation stage 34. An output of the circuit 32 is coupled by way of a low noise amplifier (LNA) 36 to another mixer 38 in which the received signal is frequency down-converted using a local oscillator signal derived from the frequency synthesiser block 26. A low pass filter 40 selects the wanted products of mixing and supplies them by way of a signal monitoring stage 42 to a demodulator stage 44. An output of the demodulator stage 44 for the received bits is coupled to an output terminal 46. A controller 48 controls the operation of the transceiver. The controller has ports coupled to the adaptive cancellation stage 36, the monitoring stage 42 and to a filter adaptation stage 50. The filter adaptation stage 50 controls a filter attenuating stage 19.

The antennas 28 and 30 will be separated by a suitable distance and be orthogonally polarised so that there is a minimum of coupling between them. The coupling is kept below some predetermined level to ensure that the LNA 36 is not saturated by the transmit signal thereby inhibiting any other scheme for cancelling the transmit signal at the receive frequency. In an alternative, non-illustrated arrangement the transmit and receive antennas could be implemented as a patch antenna with separate connection points to obtain non-overlapping radiation patterns.

The transceiver is able to simultaneously transmit wide band signals in accordance with the IEEE 802.11b standard and receive narrowband signals conforming to the Bluetooth™ standard and vice versa using the non-illustrated Bluetooth™ transmitter and IEEE 802.11b receiver mentioned above. However a recognised problem with simultaneous transmission and reception in the same frequency band is that a portion 52 of the transmitted signal is coupled back into the receiver Rx and interferes with the received signal, particularly if the received signals fall within the frequency spectrum of the transmitted signals. The interfering signal will continuously vary in amplitude, phase and delay.

In order to overcome this problem the transceiver in accordance with the present invention inserts an adaptive notch 54 (FIG. 2) of appropriate depth and bandwidth in the frequency spectrum of the transmitted signal, the position of the notch corresponds to the frequency band of the narrow band received signal 12. The controller 48 decides on the depth and bandwidth of the adaptive notch 54 in response to characteristics of the transmitted and received signals as determined by the monitoring stage 42. These characteristics include one or more of the following functions (a) the received and transmitted signal strengths, (b) the relative frequency displacements of the received and transmitted signals, and (c) the extent to which a degradation in transmitted signal quality due to the notch can be tolerated (a deep notch will degrade the error vector magnitude (EVM) in IEEE 802.11b for example). The notch is adapted to take account of when the receive and transmit signals overlap both in frequency and time, even if either system is frequency hopping. The depth of the notch directly reduces the co-channel interference of the transmitted wide band signal received by the narrowband receiver.

In the embodiment of the present invention shown in FIG. 1 one possible implementation of a notch 54 in which the amplitude of the signal to be transmitted is reduced over a frequency band corresponding to the narrow band signal is by attenuating the values of one or more taps of the FFT of the signal. This is effected by the controller 48 determining which taps should be attenuated and instructing the filter adaptation stage 50 accordingly. The filter adaptation stage 50 controls the filter attenuating stage 19 which operates on the selected filter taps. This implementation has the advantages of allowing exact control of the notch depth and because it can be easily implemented for use with IEEE 802.11. In a non-illustrated embodiment of the transceiver the FFT 18 and FFT⁻¹ 20 are replaced by a notch filter with variable centre frequency and bandwidth which could be active analogue or digital in implementation.

FIGS. 2 and 3 illustrate that the depth of the notch can vary from a position 54′ where it is disposed about the centre frequency of the transmit band and is of a relative large depth to a position offset from the centre frequency and having a smaller depth, as shown by the notch 54.

In order to enhance the performance of the method in accordance with the present invention, namely of having a notch at say the centre of the transmit frequency (notch 54′ in FIGS. 2 and 3) and/or at the centre of the receive frequencies (notch 54 in FIGS. 2 and 3), cancellation at the frequency at the centre of the transmit signal or cancellation at the frequency at which the centre of the receive signal overlaps with the transmit frequency can be implemented. For example, putting a transmit notch at the centre of the receive frequency and cancelling at the centre of the transmit signal might allow only one antenna to be used. This enhancement uses the adaptive cancellation stage 34 in FIG. 1. It should be noted however that a notch at the centre of the transmit signal is likely to degrade the transmit signal quality but some transmission standards permit such degradation.

Referring to the flow chart shown in FIG. 4, a block 60 indicates the transmitter Tx transmitting a wideband signal having a notch. Block 62 indicates the receiver Rx receiving a narrowband signal. Block 64 denotes the monitoring stage 42 (FIG. 1) monitoring the receive channel. Block 66 relates to determining if one or more of the characteristics (a) to (c) mentioned above apply. In block 68 a check is made to see if the notch requires modifying. If the answer is yes (Y) then in block 70 a decision is made to alter the depth and/or bandwidth of the notch. In block 72 the notch 54 in the transmit spectrum is altered as required. In block 74 a check is made if the transmit frequency spectrum with the altered notch is acceptable and if it is (Y) the final stage in this part of the flow chart is checking if the receiver frequency spectrum is acceptable, block 76, and if it is (Y) the flow chart reverts to an input of the block 62.

In the event of a negative response (N) from at least one of the blocks 68, 74 or 76 the flow chart reverts to the input of the block 66.

Blocks 78, 80 and 84 to 88 relate to cancellation of the centre frequency of the transmit signal in the receive signal and cancellation of the transmit signal at the centre frequency of the receive signal, respectively. The block 78 relates to checking if the transmitter centre frequency is to be cancelled in the receive signal spectrum and if it is to be cancelled (Y) block 80 relates to the cancellation of the transmit centre frequency from the receive frequency spectrum. After this block 80, the flow chart and a negative output (N) from the block 78 proceed to the block 76.

The block 84 relates to checking if the transmit signal at the receive centre frequency is to be cancelled and if it is to be cancelled (Y) the block 86 relates to determining the receive centre frequency. The block 88 relates to the cancellation of the portion of the transmit signal at the receive centre frequency from the transmit frequency spectrum. After this block 88, the flow chart and a negative output (N) from the block 84 proceed to the block 72.

For the sake of completeness FIGS. 5 to 7 illustrate why in many situations signal cancellation alone at the centre frequency of the transmit signal will not give the desired protection to the wanted receive signal.

FIG. 5 illustrates the frequency spectrums of the coupled back portion 52 of the transmit signal into the antenna 30 (FIG. 1) and the wanted receive signal 12. In this illustration both signal spectra lie in different portions of the same frequency band and the amplitude of the receive signal 12 is less by ΔA₁ than that of the coupled back portion 52 which may be sufficiently great as to saturate the LNA 36 (FIG. 1) causing distortion of both signals. FIG. 6 illustrates a cancelling signal CS at the centre of the transmit frequency as produced by the adaptive frequency cancellation stage 34. FIG. 7 illustrates the output of the frequency cancellation circuit 32 (FIG. 1) which comprises the non-cancelled portions 52′ of the coupled back portion 52 of the transmit signal and the wanted receive signal 12. However the peaks of the non-cancelled portions 52′ exceed the peak value of the receive signal 12 by ΔA₂ and could lead to distortion of the receive signal in the LNA 36.

Referring to FIG. 8, in order to protect the receive signal 12, notches N1, N2 of sufficient width and depth are introduced into the transmit signal so that the peaks of the non-cancelled portions 52′ (FIG. 7) are capped and the maximum amplitude of these capped peaks 52″ is less than the peak value of the receive signal 12 by ΔA₃. Thus by a combination of notches in the transmit frequency spectrum and frequency cancellation the receive signal 12 has been protected by avoiding the risk of saturating the LNA 36.

FIG. 9 is a simulated plot of the error vector magnitude (EVM) of a signal transmitted in accordance with the IEEE 802.11b standard as a notch of variable depth and bandwidth is introduced at different offsets from the centre.

From this it is possible to choose a notch that does not greatly degrade EVM at any particular bandwidth. In FIG. 9 the plus symbol (+) relates to the required FFT notch width equal to 300 kHz, the cross symbol (X) relates to the required FFT notch width equal to 600 kHz and the asterisk (*) relates to the required FFT notch width equal to 900 kHz.

In the plot the line referenced 90 relates to the IEEE 802.11b EVM specification of 0.35, the lines referenced 92, 93, 94 relate to an attenuation of −9 dB of the notches 300 kHz, 600 kHz and 900 kHz, respectively, the lines 96, 97, 98 relate to an attenuation of −6 dB of the respective notches, the lines 100, 101, 102 relate to an attenuation of −3 dB of the respective notches and the line 104 relates to an attenuation of 0 dB of the 900 kHz notch.

A simplified algorithm to determine the notch depth with respect to frequency offset relative to the centre of the IEEE 802.11b band is shown in the table below. As a simplification the notch bandwidth will be kept at 900 kHz as this is about the bandwidth of a Bluetooth™ signal but it is to be understood that the method in accordance with the present invention does contemplate varying the notch width as well as the notch depth with changes in frequency offset.

| Offset/MHz | Notch depth/dB |
|---|---|
| 0-5 | −3 |
| 6 | −4 |
| 7 | −6 |
| 8 | −9 |
| 9 | −12 |
| >=10 | 0 (do not use) |

These notch depth values have been chosen to make the EVM no worse than 0.3, as the specification for Bluetooth™ is 0.35.

If the difference in signal strength (RSSI) is >20 dB (Bluetooth™>IEEE 802.11b) the notch will not be used. A further refinement would be not to use the notch if the difference in signal strength is greater than some amount less than 20 dB and the offset is >0.

Using this simplified algorithm the improvement in performance (Bit Error Rate and Sensitivity) has been simulated as shown in FIG. 10. In FIG. 10 the abscissa represents Bluetooth™ signal power in dBm and the ordinate the bit error rate for reception of Bluetooth™ in the presence of IEEE 802.11b with the notch. A plus symbol (+) represents using a notch and a cross symbol (X) represents not using a notch. The lines 106, 107 represent an offset frequency of 2 MHz, the lines 108, 109 represent an offset frequency of 4 MHz, the lines 110, 111 represent an offset frequency of 6 MHz and the lines 112, 113 represent an offset frequency of 8 MHz.

Although the present invention has been described with reference to a multimode, or more specifically a dual mode transceiver, for use with simultaneous transmission and reception takes place using IEEE 802.11b and the Bluetooth™ systems, the present invention can be used in other combinations of systems in which one of the systems has a substantially wider bandwidth than another of the systems and in which true simultaneous reception and transmission is desirable, for example a combination of IEEE 802.15.3 (Wi-Media) and Zigbee (IEEE 802.15.4).

In the present specification and claims the word “a” or “an” preceding an element does not exclude the presence of a plurality of such elements. Further, the word “comprising” does not exclude the presence of other elements or steps than those listed.

From reading the present disclosure, other modifications will be apparent to persons skilled in the art. Such modifications may involve other features which are already known in the design, manufacture and use of multi-mode transceivers and component parts therefor and which may be used instead of or in addition to features already described herein.

Reference signs in the claims are by way of example only and are not intended to be limiting.

1. A method of operating a multi-mode transceiver (Tx, Rx) comprising simultaneously transmitting a signal having a relatively wide output frequency spectrum and receiving a signal having a frequency spectrum narrower than that of the output frequency spectrum but lying within the band of the transmit signal, introducing at least one notch into the output spectrum of the transmitted signal to enhance reception of the received signal and adapting at least one parameter of the notch in response to at least one operating characteristic of the transceiver.

2. A method as claimed in claim 1, characterised in that the at least one characteristic is a function of the transmitted and received signal strengths.

3. A method as claimed in claim 1, characterised in that the at least one characteristic is the extent to which a degradation in the transmitted signal quality due to the notch is tolerated.

4. A method as claimed in claim 1, characterised in that the at least one characteristic is a function of the relative frequency displacements of the transmitted and received signals.

5. A method as claimed in claim 1, characterised in that the at least one notch is at the centre of the received signal.

6. A method as claimed in claim 1, characterised in that the at least one notch is at a point in the transmit frequency spectrum which has the greatest power.

7. A method as claimed in claim 1, characterised in that the at least one notch tracks frequency hopping of the received signal.

8. A method as claimed in claim 1, characterised in that the depth of the notch is greater at edges of the transmitter frequency spectrum than at the centre of the transmitter frequency spectrum.

9. A method as claimed in claim 1, characterised by cancelling the centre frequency of the transmitted signal from an overlapping receive signal.

10. A method as claimed in claim 1, characterised by cancelling the transmit signal at the centre frequency of the receive signal.

11. A method as claimed in claim 1, characterised in that the at least one notch is created by selectively attenuating a portion of the bandwidth of the signal to be transmitted.

12. A multimode transceiver (Tx, Rx) comprising a receiver (Rx) for receiving a signal having a relatively narrow frequency spectrum, a transmitter (Tx) for transmitting a signal having an output frequency spectrum wider than that of the frequency spectrum of the received frequency spectrum, the narrow frequency spectrum and the output frequency spectrum lying within the same band, means (19) for introducing at least one notch into the output spectrum of the transmitted signal to enhance reception of the received signal and adapting means (50) for adapting at least one parameter of the at least one notch in response to at least one operating characteristic of the transceiver.

13. A transceiver as claimed in claim 12, characterised in that adapting means (50) adapts the notch in response to a function of the transmitted and received signal strengths.

14. A transceiver as claimed in claim 12, characterised in that adapting means (50) adapts the notch in response to the extent to which a degradation in the transmitted signal quality due to the notch is tolerated.

15. A transceiver as claimed in claim 12, characterised in that the adapting means (50) adapts the notch in response to a function of the relative frequency displacements of the transmitted and received signals.

16. A transceiver as claimed in claim 12, characterised in that said means (19) for introducing the at least one notch is adapted to position the at least one notch at the centre of the received signal.

17. A transceiver as claimed in claim 12, characterised in that said means (19) for introducing the at least one notch is adapted to position the at least one notch at a point of the transmit frequency spectrum which has the greatest power.

18. A transceiver as claimed in claim 12, characterised by control means (48) for causing the at least one notch to track frequency hopping of the received signal.

19. A transceiver as claimed in claim 12, characterised in that the adapting means (19) causes the depth of the notch to be greater at edges of the transmitter frequency spectrum than at the centre of the centre of the transmitter spectrum.

20. A transceiver as claimed in claim 12, characterised by cancelling means (32) for cancelling the centre frequency of the transmitted signal from an overlapping receive signal.

21. A transceiver as claimed in claim 12, characterised by cancelling means (32) for cancelling the transmit signal at the centre frequency of the receive signal.

22. A transceiver as claimed in claim 10, characterised by digital filtering means (18, 19, 20) having a plurality of taps and means (19) for selectively attenuating at least one of the plurality of taps to create the at least one notch in a portion of the bandwidth of the signal to be transmitted.
